(19) United States
(12) Patent Application Publication
(10) Pub. No.: US 2023/0118383 A1
(43) Pub. Date: Apr. 20, 2023

(54) KNIFE ATTACHMENT DEVICE FOR SLICING FRUIT OR VEGETABLE

(71) Applicants: Kichul HAN, Alameda, CA (US); Suyoung HONG, Alameda, CA (US)

(72) Inventors: Kichul HAN, Alameda, CA (US); Suyoung HONG, Alameda, CA (US)

(21) Appl. No.: 17/503,089

(22) Filed: Oct. 15, 2021

(51) Int. Cl. B26B 3/03; B26B 11/00; B26B 29/02

(52) U.S. Cl. CPC B26B 3/03; B26B 11/00; B26B 29/02; B26D 1/02

(57) ABSTRACT

A knife attachment device, for slicing a fruit or vegetable into a long strip, includes a body, first and second arms, and first and second bottom plates. The first arm and the first bottom plate are attached to each other on one end and separated and open toward the other end at or around the body such that the first arm and the first bottom plate are elastically open to receive a knife blade therein. When the knife blade is inserted, the cutting edge of the knife blade should face the attached end of the first arm and the first bottom plate. The first and second bottom plates slide on a flat surface such that the cutting edge of the knife blade slices produce and the sliced produce comes out of a space between the knife blade and the flat surface in a long strip.

### FIELD OF THE INVENTION

The present invention relates to a knife attachment device for slicing a fruit or vegetable, and more particularly, a knife attachment device for slicing a fruit or vegetable into a long strip. A knife is inserted in between an arm and a plate of the knife attachment device, and the fruit or vegetable is sliced by the cutting edge of the knife while the attachment device slides on a flat surface.

### BACKGROUND OF THE INVENTION

There are various types of fruit and vegetable cutters, slicers, and peelers, which enable easy and consistent cuts of fruits and vegetables. Such a device is usually suitable for a specific fruit or vegetable and for a specific type of cutting such as slicing, dicing, peeling, spiral cutting, etc. Here, peeling is a process of removing skin from a vegetable or fruit and spiral cutting is a process of slicing potatoes or the like into spirals.

Another type of knife cutting is Katsuramuki, which is a Japanese process of slicing a fruit or vegetable into a long strip. Katsuramuki requires a great deal of dexterity, concentration, and precision and can be difficult to master. Cutting produce, such as cucumbers, daikons, carrots, radishes, or the like into a long continuous strip with an even thickness can be very laborious. Katsuramuki, which can be very time consuming, may also cause injury; for example, cutter may get cut on his finger or hand and his wrist or fingers may become strained or numb after repetitive Katsuramuki slicing.

Therefore, to solve the above problems, a knife attachment device for slicing a fruit or vegetable into a long strip having a consistent thickness, is provided, as there is a need for a device that accomplishes this goal. This invention is directed to solve these problems and satisfy the long-felt need.

### SUMMARY OF THE INVENTION

The present invention contrives to solve the disadvantages of the prior art. The present invention provides a knife attachment device for slicing a fruit or vegetable into a long strip having a consistent thickness.

The object of the invention is to provide a knife attachment device, for slicing a fruit or vegetable into a long strip, which includes a body, first and second arms, and first and second bottom plates. The first and second arms extend from the body, and the first and second arms respectively overlie the first and second bottom plates.

The first arm and the first bottom plate are attached to each other on one end and separated and open toward the other end at or around the body such that the first arm and the first bottom plate are elastically open to receive a knife blade therein. When the knife blade is received in between the first arm and first bottom plate, the cutting edge of the knife blade should face the attached end of the first arm and the first bottom plate. Likewise, the second arm and the second bottom plate are attached to each other on one end and separated and open toward the other end at or around the body such that the second arm and the second bottom plate are elastically open to receive the knife blade therein. When the knife blade is received in between the second arm and second bottom plate, the cutting edge of the knife blade should face the attached end of the second arm and the second bottom plate. The bottom surfaces of the first and second bottom plates are flat and can easily slide along a flat surface. Thus, after the knife blade is inserted, the cutting edge of the knife blade can slice the produce such that the sliced produce comes out of a space between the knife blade and the flat surface in a long strip.

Another object of the invention is to provide the knife attachment device, for slicing a fruit or vegetable into a long strip, which includes a body, first and second arms, first and second bottom plates, and first and second middle plates. The first and second arms extend from the body, and the first and second arms respectively overlie the first and second bottom plates. Furthermore, the first and second middle plates are respectively disposed in between the first arm and the first bottom plate and in between the second arm and the second bottom plate.

The first arm, the first middle plate, and the first bottom plate are attached to each other on one end by a first retaining member and separated and open toward the other end at or around the body such that the first arm, the first middle plate, and the first bottom plate are elastically open to receive a knife blade either in between the first arm and the first middle plate or in between the first middle plate and the first bottom plate. When the knife blade is inserted, the cutting edge of the knife blade should face the attached end of the first arm, the first middle plate, and the first bottom plate. Likewise, the second arm, the second middle plate, and the second bottom plate are attached to each other on one end by a second retaining member and separated and open toward the other end at or around the body such that the second arm, the second middle plate, and the second bottom plate are elastically open to receive the knife blade either in between the second arm and the second middle plate or in between the second middle plate and the second bottom plate. When the knife blade is inserted, the cutting edge of the knife blade should face the attached end of the second arm, the second middle plate, and the second bottom plate.

The advantages of the present invention are: (1) the knife attachment device of the present invention is easy to use for slicing a fruit or vegetable into a long strip having a consistent thickness; (2) the knife attachment device of the present invention is safe, convenient, and time-saving, thus preventing injury, strain, or numbness of the user's wrist or fingers; (3) the user can quickly slice a fruit or vegetable into a long strip with an even thickness using the present invention; (4) the present invention can reduce produce waste after slicing produce into a long strip; (5) anyone can easily and conveniently use the present invention to slice a fruit or vegetable into a long strip while maintaining a consistent thickness; (6) the thickness of the long strip from the fruit or vegetable can be adjusted by inserting the knife into different slots of the present invention; (7) one embodiment of the present invention allows two thicknesses—thicker one suitable for slicing cucumber to be used for roll insert or chopped cucumber, and thinner one suitable for slicing cucumber to be used for cucumber roll or salad; (8) the present invention has a simple structure, but is very effective in slicing a fruit or vegetable into a long strip; (9) the cost to manufacture the present invention is low because of its simple structure; (10) the present invention is easy to manufacture, which further reduces manufacturing costs; and (11) the present invention can be attached to a display case or refrigerator by magnets, and thus, it can be conveniently used.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a top perspective view of a knife attachment device according to one embodiment of the present invention;

FIG. 2A shows a perspective view of the knife attachment device according to one embodiment of the present invention where a knife is inserted into the upper slot of the knife attachment device;

FIG. 2B shows a perspective view of the knife attachment device according to one embodiment of the present invention where the knife is inserted into the lower slot of the knife attachment device;

FIG. 3A shows a top view of the knife attachment device according to one embodiment of the present invention where the knife is inserted into the knife attachment device;

FIG. 3B shows a bottom view of the knife attachment device according to one embodiment of the present invention where the knife is inserted into the knife attachment device;

FIG. 4 shows a side view of the knife attachment device according to one embodiment of the present invention where the knife is inserted into the knife attachment device;

FIG. 5 shows a bottom perspective view of the knife attachment device according to one embodiment of the present invention;

FIG. 6 shows a top view of the knife attachment device according to one embodiment of the present invention;

FIG. 7 shows a bottom view of the knife attachment device according to one embodiment of the present invention;

FIG. 8 shows a side view of the knife attachment device according to one embodiment of the present invention;

FIG. 9 shows another side view of the knife attachment device according to one embodiment of the present invention;

FIG. 10 shows still another side view of the knife attachment device according to one embodiment of the present invention;

FIG. 11 shows still another side view of the knife attachment device according to one embodiment of the present invention;

FIG. 12 shows still another side view of the knife attachment device according to another embodiment of the present invention; and

FIG. 13 shows a user which uses the knife attachment device of the present invention to slice an object into a long strip.

### DETAILED DESCRIPTION OF EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

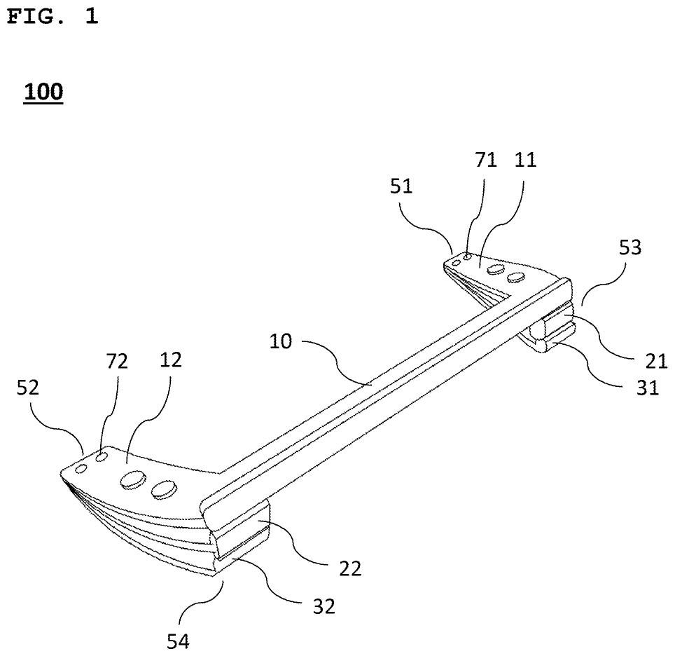

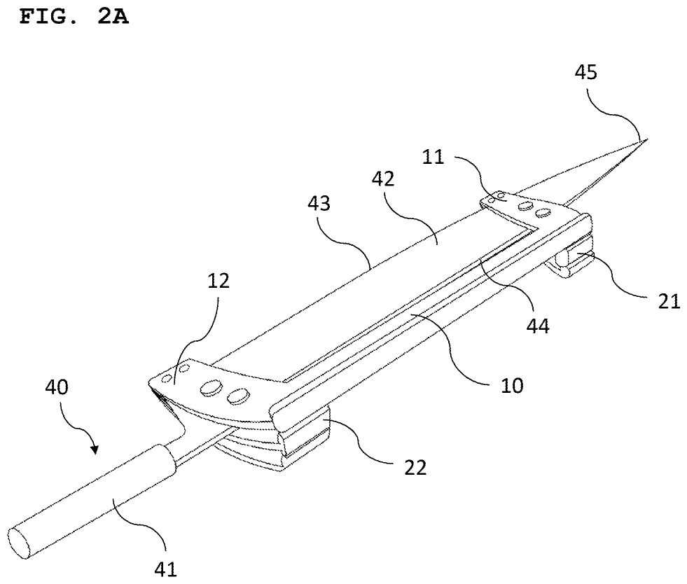

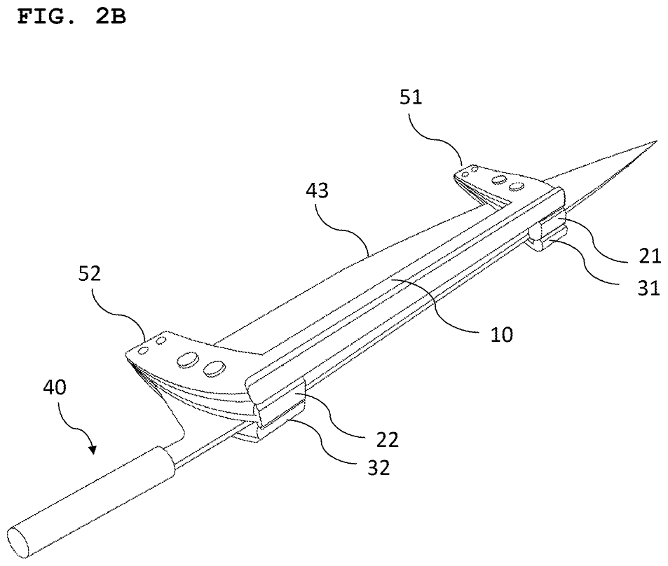

FIGS. 1, 2A, and 2B show perspective views of a knife attachment device according to one embodiment of the present invention. The knife attachment device 100 for slicing a fruit or vegetable 200 into a long strip 210 includes a body 10, first and second arms 11, 12, and first and second bottom plates 31, 32. As shown in FIG. 1, the first and second arms 11, 12 extend from the body 10, and the first and second arms 11, 12 respectively overlie the first and second bottom plates 31, 32.

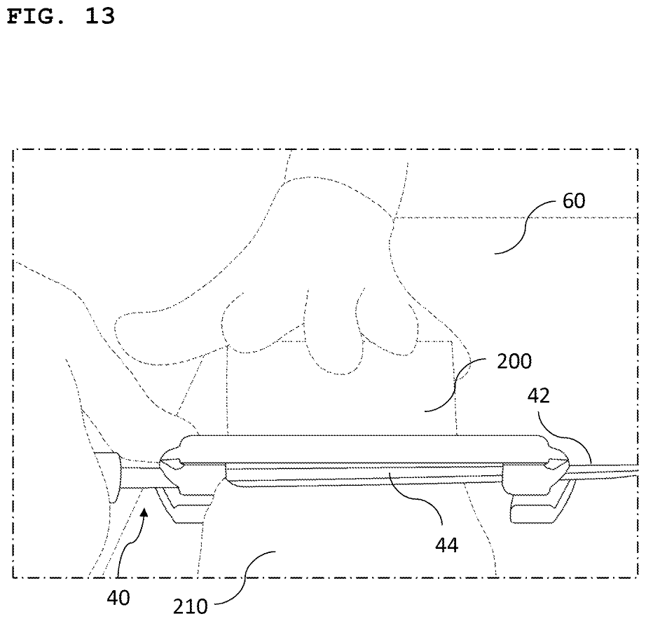

The first arm 11 and the first bottom plate 31 are attached to each other on one end 51 and separated and open toward the other end 53 at or around the body 10 such that the first arm 11 and the first bottom plate 31 are elastically open to receive a knife blade 42 therein. When the knife blade 43 is inserted, the cutting edge 43 of the knife blade 42 should face the attached end 51 of the first arm 11 and the first bottom plate 31 and the spine 44 of the knife blade 42 should face the body 10. Likewise, the second arm 12 and the second bottom plate 32 are attached to each other on one end 52 and separated and open toward the other end 54 at or around the body 10 such that the second arm 12 and the second bottom plate 32 are elastically open to receive the knife blade 42 therein. When the knife blade 42 is inserted, the cutting edge 43 of the knife blade 42 should face the attached end 52 of the second arm 12 and the second bottom plate 32 and the spine 44 of the knife blade 42 should face the body 10. The bottom surfaces of the first and second bottom plates 31, 32 are flat and easily slide on a flat surface 60. Thus, after the knife blade 42 is inserted as shown in FIG. 2A or 2B, the cutting edge 43 of the knife blade 42 can slice the produce 200 such that the sliced produce 200 comes out of a space between the knife blade 42 and the flat surface 60 in a long strip 210 as shown in FIG. 13.

The first arm 11 and the first bottom plate 31 are made of elastic material so that they can be elastically open to receive a knife blade 42 therein. They may be made of same material, or the first bottom plate 31 may be made of more rigid material than the first arm 11 so that the bottom surface of the first bottom plate 31 is flat to slide on a flat surface. Likewise, the second arm 12 and the second bottom plate 32 are made of elastic material so that they can be elastically open to receive a knife blade 42 therein. They may be made of same material, or the second bottom plate 32 may be made of more rigid material than the second arm 12 so that the bottom surface of the second bottom plate 32 is flat to slide on a flat surface. Preferably, the first arm 11, the first bottom plate 31, the second arm 12, and the second bottom plate 32 may be made of plastic, polyethylene (PE), acrylic or other like materials. They need to be elastic enough to receive and retain the knife blade 42.

The knife attachment device 100 may further include first and second middle plates 21, 22. The first middle plate 21 is disposed in between the first arm 11 and the first bottom plate 31 and the second middle plate 22 is disposed in between the second arm 12 and the second bottom plate 32. As shown in FIG. 1, the first arm 11, the first middle plate 21, and the first bottom plate 31 are attached to each other on one end 51 and separated and open toward the other end 53 at or around the body 10 such that the first arm 11, the first middle plate 21, and the first bottom plate 31 are elastically open to receive the knife blade 42 either in the upper slot of between the first arm 11 and the first middle plate 21 or in the lower slot of between the first middle plate 21 and the first bottom plate 31. When the knife blade 42 is inserted in the upper slot or the lower slot, the cutting edge 43 of the knife blade 42 should face the attached end 51 of the first arm 11, the first middle plate 21, and the first bottom plate 31 and the spine 44 of the knife blade 42 should face the body 10. Likewise, the second arm 12, the second middle plate 22, and the second bottom plate 32 are attached to each other on one end 52 and separated and open toward the other end 54 at or around the body 10 such that the second arm 12, the second middle plate 22, and the second bottom plate 32 are elastically open to receive the knife blade 42 either in the upper slot of between the second arm 12 and the second middle plate 22 or in the lower slot of between the second middle plate 22 and the second bottom plate 32. When the knife blade 42 is inserted in the upper slot or lower slot, the cutting edge 43 of the knife blade 42 should face the attached end 52 of the second arm 12, the second middle plate 22 and the second bottom plate 32 and the spine 44 of the knife blade 42 should face the body 10. In the alternative embodiment, the knife attachment device 100 may further include additional first and second middle plates so that the device 100 can have additional slot(s) to receive the knife blade 42 therein.

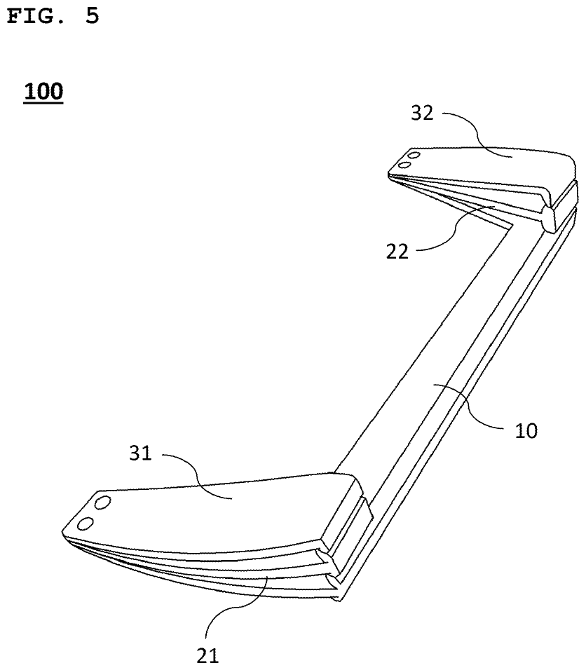

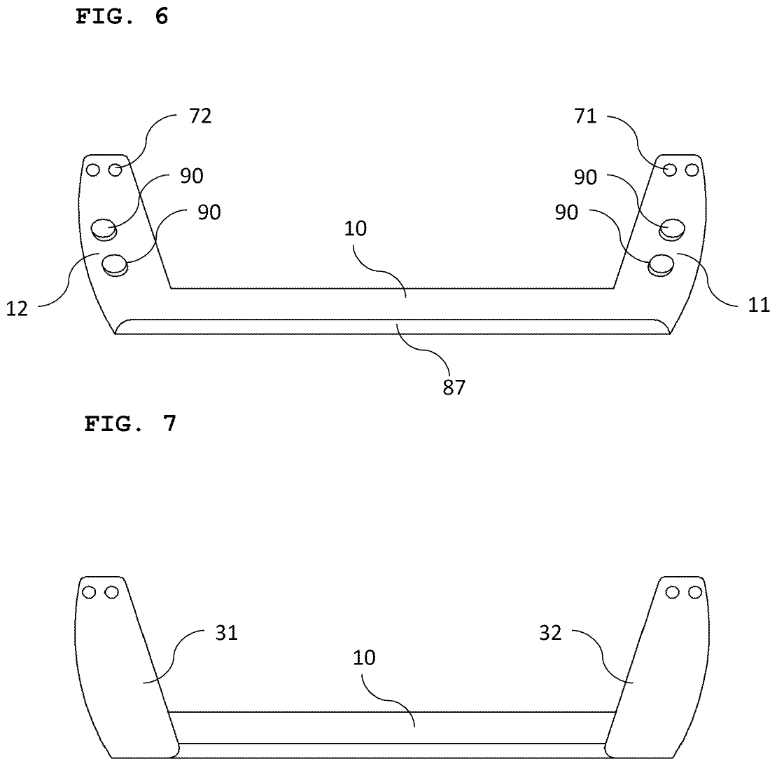

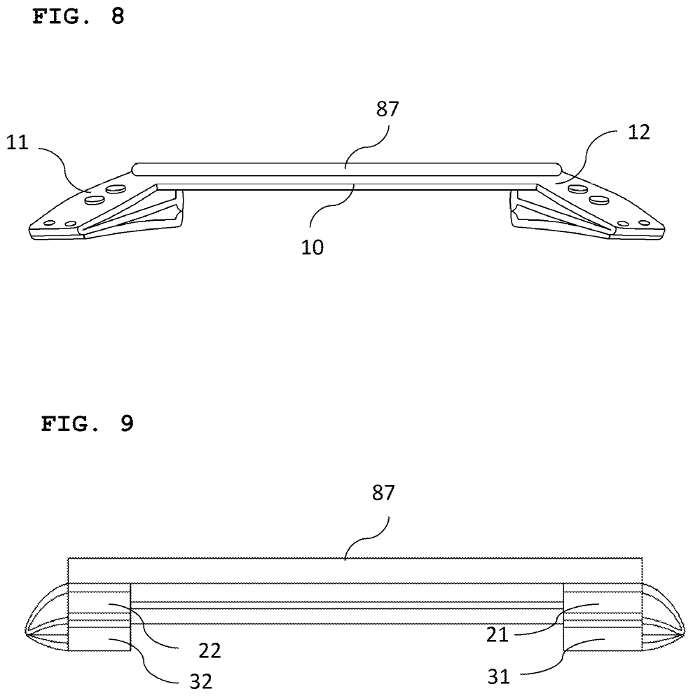

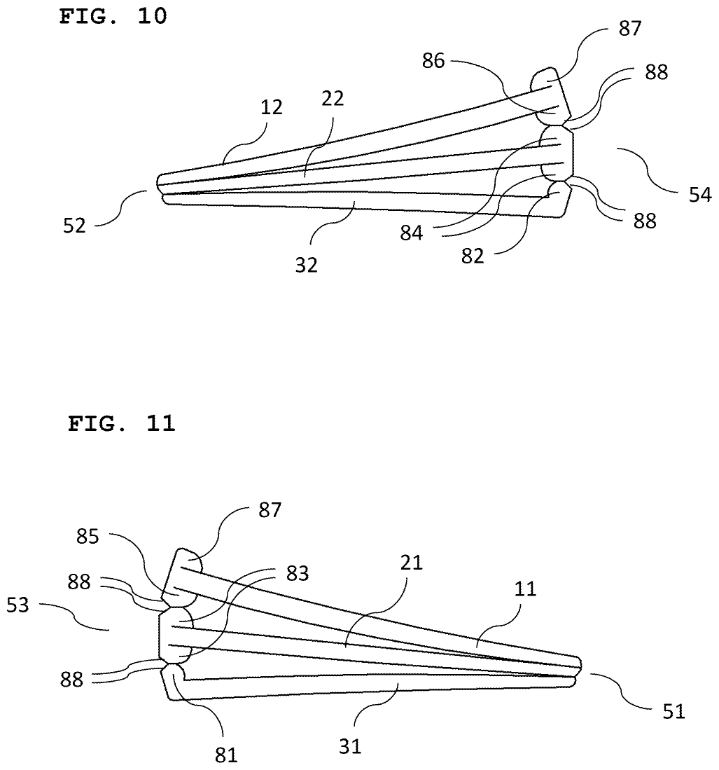

The first arm 11, the first middle plate 21, and the first bottom plate 31 may be attached to each other on the one end 51 by a first retaining member 71, and the second arm 12, the second middle plate 22, and the second bottom plate 32 may be attached to each other on the one end 52 by a second retaining member 72. The retaining members 71, 72 may be a metal pin received and fixedly attached to the through-holes which are formed on the attached end 51, 52 of the arm 11, 12 and plates 21, 31, 22, 32. As shown in FIGS. 1, 5, 6, 7, 10, and 11, the metal pins are not protruded out beyond the outer surfaces of the arms 11, 12 or the bottom plates 31, 32.

The first arm 11, the first middle plate 21, and the first bottom plate 31 may be manufactured separately and attached to each other on the one end 51. Alternatively, the first arm 11, the first middle plate 21, and the first bottom plate 31 may be integrally manufactured as a single piece to be elastic. Likewise, the second arm 12, the second middle plate 22, and the second bottom plate 32 may be manufactured separately, or integrally manufactured as a single piece to be elastic.

As shown in FIGS. 1, 5, 10, 11, and 12, the first bottom plate 31 may have a ridge 81 formed along the other end 53 to prevent the knife blade 42 from being dislodged from the knife attachment device 100. Likewise, the second bottom plate 32 may have a ridge 82 formed along the other end 54 to prevent the knife blade 42 from being dislodged from the knife attachment device 100; the first middle plate 21 may have a ridge 83 upwardly and downwardly formed along the other end 53 to prevent the knife blade 42 from being dislodged from the knife attachment device 100; the second middle plate 22 may have a ridge 84 formed upwardly and downwardly along the other end 54 to prevent the knife blade 42 from being dislodged from the knife attachment device 100; the first arm 11 may have a ridge 85 formed along the other end 53 to prevent the knife blade 42 from being dislodged from the knife attachment device 100; and the second arm 12 may have a ridge 86 formed along the other end 54 to prevent the knife blade 42 from being dislodged from the knife attachment device 100. The ridges 85, 86 may be connected to each other as a single piece as shown FIG. 1 and there may be an additional ridge 87 upwardly formed on the body 10.

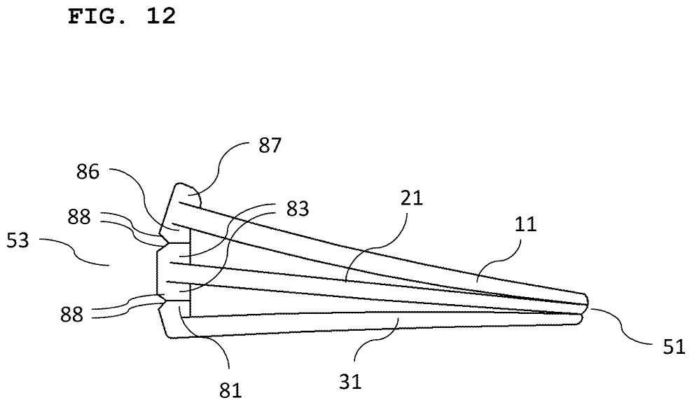

As shown in FIG. 11, the inner side of the ridges may have bevels as well. Alternatively, as in FIG. 12, the inner side of the ridges may not have bevels.

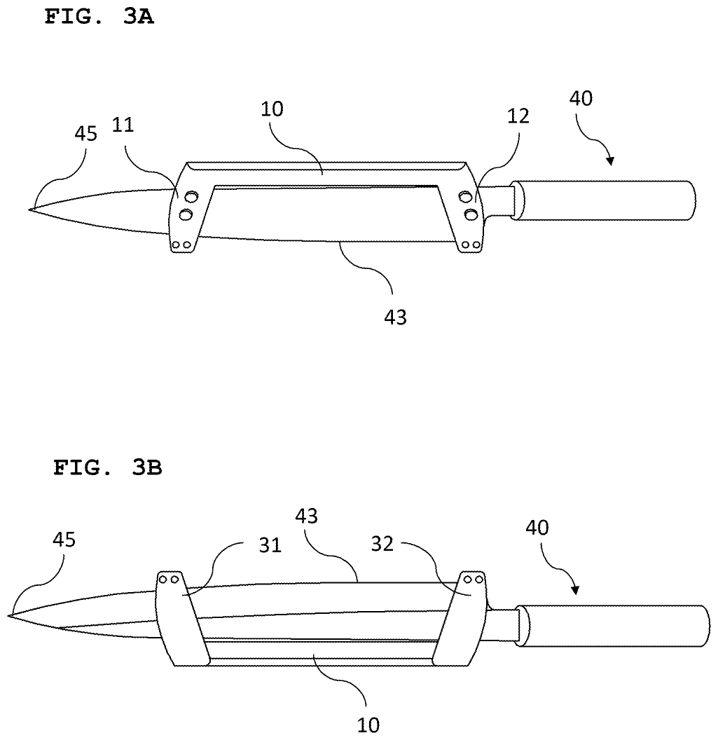

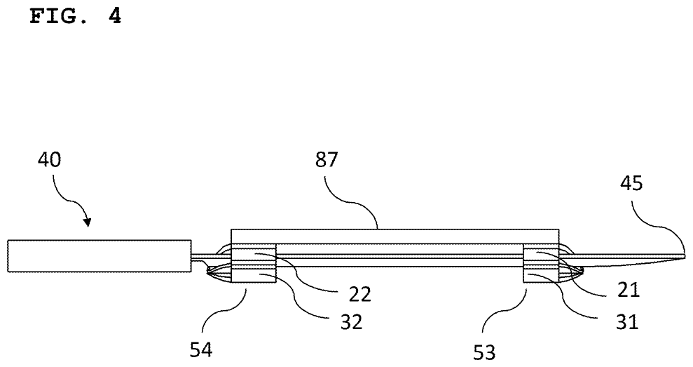

As shown in FIGS. 2A, 2B, 3A, 3B, and 4, the first and second arms 11, 12 are spaced apart such that a tip 45 of the knife blade 42 can be placed outward of the first arm 11 for a right-handed user or second arm 12 for a left-handed user. In this structure, the tip 45 of the knife blade 42 can be used to cut the long strip 210 of the fruit or vegetable 200 after slicing.

The first arm 11 and the first bottom plate 31 may be attached to each other on the one end 51 by a first retaining member 71, and the second arm 12 and the second bottom plate 32 may be attached to each other on the one end 52 by a second retaining member 72. The first and second retaining members 71, 72 may be a pin, preferably a cylindrical metal pin which is received in a through-hole by glue. As shown in FIG. 1, there are two pins respectively for the first and second arms 11, 12.

The first arm 11 and the first bottom plate 31 may be manufactured separately and attached to each other, or integrally manufactured as a single piece to be elastic. Likewise, the second arm 12 and the second bottom plate 32 may be manufactured separately and attached to each other, or integrally manufactured as a single piece to be elastic. When integrally manufactured, the body 10, the first and second arms 11, 12, and the first and second bottom plates 31, 32 can be integrally manufactured as a single piece.

The first bottom plate 31 may have a ridge 81 formed along the other end 53 to prevent the knife blade 42 from being dislodged from the knife attachment device 100. Likewise, the second bottom plate 32 may have a ridge 82 formed along the other end 54 to prevent the knife blade 42 from being dislodged from the knife attachment device 100; the first arm 11 may have a ridge 85 formed along the other end 53 to prevent the knife blade 42 from being dislodged from the knife attachment device 100; and the second arm 12 may have a ridge 86 formed along the other end 54 to prevent the knife blade 42 from being dislodged from the knife attachment device 100. Furthermore, a bevel 88 may be formed along the ridge 85 of the first arm 11 for easy insertion of the knife blade 42. Likewise, additional bevels 88 may be formed along the ridge 86 of the second arm 12, along the ridge 81 of the first bottom plate 31 for easy insertion of the knife blade 42, and along the ridge 82 of the second bottom plate 32 for easy insertion of the knife blade 42.

The first arm 11 may further comprise a magnet 90 and the second arm 12 may further comprise a magnet 90. The magnets 90 enable the knife attachment device 100 attachable to a showcase or refrigerator for convenient placement and use.

In the alternative embodiment, the knife attachment device 100, for slicing a fruit or vegetable 200 into a long strip 210, includes a body 10, first and second arms 11, 12, first and second bottom plates 31, 32, and first and second middle plates 21, 22. The first and second arms 11, 12 extend from the body 10, and the first and second arms 11, 12 respectively overlie the first and second bottom plates 31, 32. Furthermore, the first and second middle plates 21, 22 are respectively disposed in between the first arm 11 and the first bottom plate 31 and in between the second arm 12 and the second bottom plate 32.

The first arm 11, the first middle plate 21, and the first bottom plate 31 are attached on one end 51 by a first retaining member 71 and open toward the other end 52 at or around the body 10 such that the first arm 11, the first middle plate 21, and the first bottom plate 31 elastically open to receive a knife blade 42 either in between the first arm 11 and the first middle plate 21 or in between the first middle plate 21 and the first bottom plate 31 so that the cutting edge 43 of the knife blade 42 faces the attached end 51 of the first arm 11, the first middle plate 21, and the first bottom plate 31. Likewise, the second arm 12, the second middle plate 22, and the second bottom plate 32 are attached on one end 52 by a second retaining member 72 and open toward the other end 54 at or around the body 10 such that the second arm 12, the second middle plate 22, and the second bottom plate 32 elastically open to receive the knife blade 42 either in between the second arm 12 and the second middle plate 22 or in between the second middle plate 22 and the second bottom plate 32 so that the cutting edge 43 of the knife blade 42 faces the attached end 52 of the second arm 12, the second middle plate 22, and the second bottom plate 32.

The first retaining member 71 may be a first cylindrical pin and the second retaining member 72 may be a second cylindrical pin. A first pass-through hole is formed on the first arm 11, the first middle plate 21, and the first bottom plate 31 such that the first cylindrical pin is received in the first pass-through hole and attached to the first arm 11, the first middle plate 21, and the first bottom plate 31 by glue and the first cylindrical pin does not protrude beyond a surface of the first bottom plate 31. Likewise, a second pass-through hole is formed on the second arm 12, the second middle plate 22, and the second bottom plate 32 such that the second cylindrical pin is received in the second pass-through hole and attached to the second arm 12, the second middle plate 22, and the second bottom plate 32 by glue and the second cylindrical pin does not protrude beyond a surface of the second bottom plate 32.

The first and second arms 11, 12 are spaced apart so that a tip 45 of the knife blade 42 can be placed outward of the first arm 11 or second arm 12. In this structure, the tip 45 of the knife blade 42 can be used to cut produce.

The first bottom plate 31 may have a ridge 81 formed along the other end 53 to prevent the knife blade 42 from being dislodged from the knife attachment device 100. Likewise, the second bottom plate 32 may have a ridge 82 formed along the other end 54 to prevent the knife blade 42 from being dislodged from the knife attachment device 100; the first middle plate 21 may have a ridge 83 upwardly and downwardly formed along the other end 53 to prevent the knife blade 42 from being dislodged from the knife attachment device 100; the second middle plate 22 may have a ridge 84 formed upwardly and downwardly along the other end 54 to prevent the knife blade 42 from being dislodged from the knife attachment device 100; the first arm 11 may have a ridge 85 formed along the other end 53 to prevent the knife blade 42 from being dislodged from the knife attachment device 100; and the second arm 12 may have a ridge 86 formed along the other end 54 to prevent the knife blade 42 from being dislodged from the knife attachment device 100.

A bevel 88 may be formed along the ridge 85 of the first arm 11 for easy insertion of the knife blade 42. Likewise, bevels 88 may be formed along the ridge 86 of the second arm 12, along the ridge 83 of the first middle plate 21, along the ridge 84 of the second middle plate 22, along the ridge 81 of the first bottom plate 31, and along the ridge 82 of the second bottom plate 32 for easy insertion of the knife blade 42.

The knife attachment device may further comprise a first magnet 90 received in a hole of the first arm 11 and a second magnet 90 received in a hole of the second arm 12. The magnets 90 are fixedly attached to the holes by glue.

While the invention has been shown and described with reference to different embodiments thereof, it will be appreciated by those skilled in the art that variations in form, detail, compositions and operation may be made without departing from the spirit and scope of the invention as defined by accompanying claims.

What is claimed is:

1. A knife attachment device for slicing a fruit or vegetable into a long strip, comprising:
a body;
first and second arms extending from the body; and
first and second bottom plates wherein the first and second arms respectively overlie the first and second bottom plates, wherein the first arm and the first bottom plate are attached to each other on one end and separated and open toward the other end at or around the body such that the first arm and the first bottom plate are elastically open to receive a knife blade therein so that a cutting edge of the knife blade faces the attached end of the first arm and the first bottom plate, wherein the second arm and the second bottom plate are attached to each other on one end and separated and open toward the other end at or around the body such that the second arm and the second bottom plate are elastically open to receive the knife blade therein so that the cutting edge of the knife blade faces the attached end of the second arm and the second bottom plate, wherein the first and second bottom plates are constructed to slide on a flat surface such that the cutting edge of the knife blade slices the fruit or vegetable and the sliced fruit or vegetable comes out of a space between the knife blade and the flat surface in the long strip.

2. The knife attachment device of claim 1, further comprising first and second middle plates wherein the first middle plate is disposed in between the first arm and the first bottom plate and the second middle plate is disposed in between the second arm and the second bottom plate,
wherein the first arm, the first middle plate, and the first bottom plate are attached to each other on one end and separated and open toward the other end at or around the body such that the first arm, the first middle plate, and the first bottom plate are elastically open to receive the knife blade either in between the first arm and the first middle plate or in between the first middle plate and the first bottom plate so that the cutting edge of the knife blade faces the attached end of the first arm, the first middle plate, and the first bottom plate, wherein the second arm, the second middle plate, and the second bottom plate are attached to each other on one end and separated and open toward the other end at or around the body such that the second arm, the second middle plate, and the second bottom plate are elastically open to receive the knife blade either in between the second arm and the second middle plate or in between the second middle plate and the second bottom plate so that the cutting edge of the knife blade faces the attached end of the second arm, the second middle plate, and the second bottom plate.

3. The knife attachment device of claim 2, wherein the first arm, the first middle plate, and the first bottom plate are attached to each other on the one end by a first retaining member, and
wherein the second arm, the second middle plate, and the second bottom plate are attached to each other on the one end by a second retaining member.

4. The knife attachment device of claim 2, wherein the first arm, the first middle plate, and the first bottom plate are integrally manufactured as a single piece, and
wherein the second arm, the second middle plate, and the second bottom plate are integrally manufactured as a single piece.

5. The knife attachment device of claim 2, wherein the first bottom plate has a ridge formed along the other end to prevent the knife blade from being dislodged from the knife attachment device,
wherein the second bottom plate has a ridge formed along the other end to prevent the knife blade from being dislodged from the knife attachment device,
wherein the first middle plate has a ridge upwardly and downwardly formed along the other end to prevent the knife blade from being dislodged from the knife attachment device,
wherein the second middle plate has a ridge formed upwardly and downwardly along the other end to prevent the knife blade from being dislodged from the knife attachment device,
wherein the first arm has a ridge formed along the other end to prevent the knife blade from being dislodged from the knife attachment device,
wherein the second arm has a ridge formed along the other end to prevent the knife blade from being dislodged from the knife attachment device.

6. The knife attachment device of claim 1, wherein the first and second arms are spaced apart such that a tip of the knife blade can be placed outward of the first arm or second arm.

7. The knife attachment device of claim 1, wherein the first arm and the first bottom plate are attached to each other on the one end by a first retaining member, and
wherein the second arm and the second bottom plate are attached to each other on the one end by a second retaining member.

8. The knife attachment device of claim 7, wherein the first retaining member is a pin and the second retaining member is a pin.

9. The knife attachment device of claim 1, wherein the first arm and the first bottom plate are integrally manufactured as a single piece, and
wherein the second arm and the second bottom plate are integrally manufactured as a single piece.

10. The knife attachment device of claim 1, wherein the first bottom plate has a ridge formed along the other end to prevent the knife blade from being dislodged from the knife attachment device, and
wherein the second bottom plate has a ridge formed along the other end to prevent the knife blade from being dislodged from the knife attachment device.

11. The knife attachment device of claim 10, wherein the first arm has a ridge formed along the other end to prevent the knife blade from being dislodged from the knife attachment device, and wherein the second arm has a ridge formed along the other end to prevent the knife blade from being dislodged from the knife attachment device.

12. The knife attachment device of claim 11, wherein a bevel is formed along the ridge of the first arm for easy insertion of the knife blade,
wherein a bevel is formed along the ridge of the second arm for easy insertion of the knife blade,
wherein a bevel is formed along the ridge of the first bottom plate for easy insertion of the knife blade, and
wherein a bevel is formed along the ridge of the second bottom plate for easy insertion of the knife blade.

13. The knife attachment device of claim 1, wherein the first arm comprises a magnet and the second arm comprises a magnet.

14. A knife attachment device for slicing a fruit or vegetable into a long strip, comprising:
a body;
first and second arms extending from the body;
first and second bottom plates wherein the first and second arms respectively overlie the first and second bottom plates;
first and second middle plates wherein the first and second middle plates are respectively disposed in between the first arm and the first bottom plate and in between the second arm and the second bottom plate,
wherein the first arm, the first middle plate, and the first bottom plate are attached to each other on one end by a first retaining member and separated and open toward the other end at or around the body such that the first arm, the first middle plate, and the first bottom plate are elastically open to receive a knife blade either in between the first arm and the first middle plate or in between the first middle plate and the first bottom plate so that the cutting edge of the knife blade faces the attached end of the first arm, the first middle plate, and the first bottom plate,
wherein the second arm, the second middle plate, and the second bottom plate are attached to each other on one end by a second retaining member and separated and open toward the other end at or around the body such that the second arm, the second middle plate, and the second bottom plate are elastically open to receive the knife blade either in between the second arm and the second middle plate or in between the second middle plate and the second bottom plate so that the cutting edge of the knife blade faces the attached end of the second arm, the second middle plate, and the second bottom plate.

15. The knife attachment device of claim 14, wherein the first retaining member is a first cylindrical pin and the second retaining member is a second cylindrical pin.

16. The knife attachment device of claim 15, wherein a first pass-through hole is formed on the first arm, the first middle plate, and the first bottom plate such that the first cylindrical pin is received in the first pass-through hole and attached to the first arm, the first middle plate, and the first bottom plate by glue and the first cylindrical pin does not protrude beyond a surface of the first bottom plate, and
wherein a second pass-through hole is formed on the second arm, the second middle plate, and the second bottom plate such that the second cylindrical pin is received in the second pass-through hole and attached to the second arm, the second middle plate, and the second bottom plate by glue and the second cylindrical pin does not protrude beyond a surface of the second bottom plate.

17. The knife attachment device of claim 14, wherein the first and second arms are spaced apart so that a tip of the knife blade can be placed outward of the first arm or second arm.

18. The knife attachment device of claim 14, wherein the first bottom plate has a ridge formed along the other end to prevent the knife blade from being dislodged from the knife attachment device,
wherein the second bottom plate has a ridge formed along the other end to prevent the knife blade from being dislodged from the knife attachment device,
wherein the first middle plate has a ridge upwardly and downwardly formed along the other end to prevent the knife blade from being dislodged from the knife attachment device,
wherein the second middle plate has a ridge formed upwardly and downwardly along the other end to prevent the knife blade from being dislodged from the knife attachment device,
wherein the first arm has a ridge formed along the other end to prevent the knife blade from being dislodged from the knife attachment device,
wherein the second arm has a ridge formed along the other end to prevent the knife blade from being dislodged from the knife attachment device.

19. The knife attachment device of claim 18, wherein a bevel is formed along the ridge of the first arm for easy insertion of the knife blade,
wherein a bevel is formed along the ridge of the second arm for easy insertion of the knife blade,
wherein a bevel is formed along the ridge of the first middle plate for easy insertion of the knife blade,
wherein a bevel is formed along the ridge of the second middle plate for easy insertion of the knife blade,
wherein a bevel is formed along the ridge of the first bottom plate for easy insertion of the knife blade, and
wherein a bevel is formed along the ridge of the second bottom plate for easy insertion of the knife blade.

20. The knife attachment device of claim 14, further comprising a first magnet received in a hole of the first arm; and a second magnet received in a hole of the second arm.
